(19) United States
(12) Patent Application Publication
(10) Pub. No.: US 2025/0265669 A1
(43) Pub. Date: Aug. 21, 2025

(54) SYSTEMS AND METHODS FOR OPTIMIZING DETERRENT EFFECTS OF CRIMINAL PUNISHMENTS

(71) Applicant: Joshua W. Hunking, Albany, OR (US)

(72) Inventor: Joshua W. Hunking, Albany, OR (US)

(21) Appl. No.: 19/053,839

(22) Filed: Feb. 14, 2025

Related U.S. Application Data
(60) Provisional application No. 63/554,053, filed on Feb. 15, 2024.

(51) Int. Cl. G06Q 50/26

(52) U.S. Cl. CPC G06Q 50/26

(57) ABSTRACT

A criminal punishment optimization system that maximizes the deterrent effect of criminal punishments while minimizing recidivate behavior and the cost to taxpayers. The system receives, from a device associated with a sentencing authority, a sentencing request to punish an offender convicted of a crime. The system determines a type of harm for the offender criminal record and identifies a group of criminal records from a criminal record database that are associated with the type of harm. The system segments the group of criminal records into recidivate criminal records and non-recidivate criminal records and determines a sentencing threshold separates the recidivate criminal records from the non-recidivate criminal records. The system generates metrics for the offender and adjusts the sentencing threshold based on the metrics. The system also delivers the adjusted sentence to the device associated with the sentencing authority.

### CROSS-REFERENCE TO RELATED APPLICATIONS

The present application claims priority to U.S. Provisional Patent Application Ser. No. 63/554,053, filed on Feb. 15, 2024, the content of which is herein incorporated by reference in its entirety.

### TECHNICAL FIELD

The present disclosure relates generally to systems and methods for optimizing criminal sentencing guidelines that maximize the deterrent effect of criminal punishments while minimizing recidivate behavior and the cost to taxpayers in implementing the criminal punishments.

### BACKGROUND

In the 19th century, the “Angel of Prisons,” otherwise known as British prison reformer Elizabeth Fry, penned “punishment is not for revenge, but to lessen crime and reform the criminal.” Indeed, this quote underscores one of the primary goals of our criminal justice system, namely, reducing future instances of repeat criminal behavior, or in other words, reducing recidivism. Historically, recidivism rates have been the benchmark for determining whether our judicial system is successful in deterring future instances of repeat criminal behavior. A recidivism rate may be calculated by totaling the number of criminal convictions and the number of criminal convictions by repeat offenders over a period of time, and dividing the number of convictions by repeat offenders by the total number of convictions.

While recidivism rates have been used to measure the deterrent effect of criminal punishments, recidivism rates generally do not account for the costs of administering the criminal punishment on the judicial system or other factors related to society, such as the costs of harm to society associated with the criminal behavior or how an offender's engagement with society and unique circumstances affects recidivism. For example, the current standard for criminal sentencing guidelines, the Federal Sentencing Guidelines, generally do not account for the costs associated with administering the criminal punishment to the judicial system nor the costs on society caused by the criminal activity. As current systems fail to account for these costs, criminal punishments may be administered in an extremely cost-ineffective manner, thereby costing taxpayers, the judicial system, and society millions of dollars more than required to effectively reduce the recidivism rates. Moreover, the failure of current systems to account for societal factors unique to an offender further compound this problem. Thus, current systems fail to provide an optimized sentencing guideline for criminal punishments that balances the costs of administering the criminal punishment with effectively reducing the recidivism rate for the criminal offender.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of an example communication network (e.g., the Internet) and a criminal punishment optimization system in accordance with one or more embodiments described herein;

FIG. 2 illustrates a schematic block diagram of an example node/device that may be used with one or more embodiments described herein;

FIG. 3 illustrates a schematic block diagram depicting the components of criminal punishment optimization system in accordance with one or more embodiments described herein;

FIG. 4 illustrates a schematic block diagram showing operations and data flow for criminal punishment optimization system in accordance with one or more embodiments described herein;

FIG. 5 illustrates a schematic block diagram showing an end-to-end example of the criminal punishment optimization system in accordance with one or more embodiments described herein; and

FIG. 6 illustrates an example simplified procedure for generating an optimized criminal sentencing guideline in accordance with one or more embodiments described herein.

### DESCRIPTION OF EXAMPLE EMBODIMENTS

### Overview

According to one or more embodiments of the disclosure, the techniques described herein relate to a criminal punishment optimization system, including: one or more network interfaces to communicate with a plurality of devices over a communication network; a processor coupled to the network interfaces and adapted to execute one or more processes; and a memory configured to store a process executable by the processor, the process, when executed is operable to: receive, from a device associated with a sentencing authority, a sentencing request to punish an offender convicted of a crime, the offender being associated with an offender criminal record and offender personal information; determine a type of harm for the offender criminal record based on at least one societal harm category; identify a group of criminal records from a criminal record database that are associated with the type of harm for the offender criminal record, each criminal record of the group of criminal records including at least data associated with a criminal behavior of a criminal; segment the group of criminal records into a group of recidivate criminal records and a group of non-recidivate criminal records based on the data associated with the criminal behavior of the criminal for each criminal record; determine a sentencing threshold separates the group of recidivate criminal records from the group of non-recidivate criminal records; generate a societal engagement metric for the offender based on the offender personal information, wherein the societal engagement metric is indicative of a connection to society for the offender; adjust the sentencing threshold based on the societal engagement metric for the offender to generate an adjusted sentence; and deliver the adjusted sentence to the device associated with the sentencing authority.

According to one or more embodiments of the disclosure, the techniques described herein relate to a method for optimizing criminal sentencing including: receiving, from a device associated with a sentencing authority, a sentencing request to punish an offender convicted of a crime, the offender being associated with an offender criminal record and offender personal information; determining a type of harm for the offender criminal record based on at least one societal harm category; identifying a group of criminal records from a criminal record database that are associated with the type of harm for the offender criminal record, each criminal record of the group of criminal records including at least data associated with a criminal behavior of a criminal; segmenting the group of criminal records into a group of recidivate criminal records and a group of non-recidivate criminal records based on the data associated with the criminal behavior of the criminal for each criminal record; determining a sentencing threshold separates the group of recidivate criminal records from the group of non-recidivate criminal records; generating a societal engagement metric for the offender based on the offender personal information, wherein the societal engagement metric is indicative of a connection to society for the offender; adjusting the sentencing threshold based on the societal engagement metric for the offender to generate an adjusted sentence; and delivering the adjusted sentence to the device associated with the sentencing authority.

According to one or more embodiments of the disclosure, the techniques described herein relate to a tangible, non-transitory, computer-readable media having instructions encoded thereon, the instructions, when executed by a processor, are operable to: receive, from a device associated with a sentencing authority, a sentencing request to punish an offender convicted of a crime, the offender being associated with an offender criminal record and offender personal information; determine a type of harm for the offender criminal record based on at least one societal harm category; identify a group of criminal records from a criminal record database that are associated with the type of harm for the offender criminal record, each criminal record of the group of criminal records including at least data associated with a criminal behavior of a criminal; segment the group of criminal records into a group of recidivate criminal records and a group of non-recidivate criminal records based on the data associated with the criminal behavior of the criminal for each criminal record; determine a sentencing threshold separates the group of recidivate criminal records from the group of non-recidivate criminal records; generate a societal engagement metric for the offender based on the offender personal information, wherein the societal engagement metric is indicative of a connection to society for the offender; adjust the sentencing threshold based on the societal engagement metric for the offender to generate an adjusted sentence; and deliver the adjusted sentence to the device associated with the sentencing authority.

### Description

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

An environment for optimizing criminal punishments may include a communication network, which is a geographically distributed collection of nodes interconnected by communication links and segments for transporting data between end nodes, such as mobile devices, computers, personal computing devices (and so on), and other devices, such as network entities, sensors, etc. Many types of networks are available, ranging from local area networks (LANs) to wide area networks (WANs). LANs typically connect these nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, etc. Some communication networks can include telecommunication networks, which transport data between end nodes, such as user equipment (UE), which can include mobile devices.

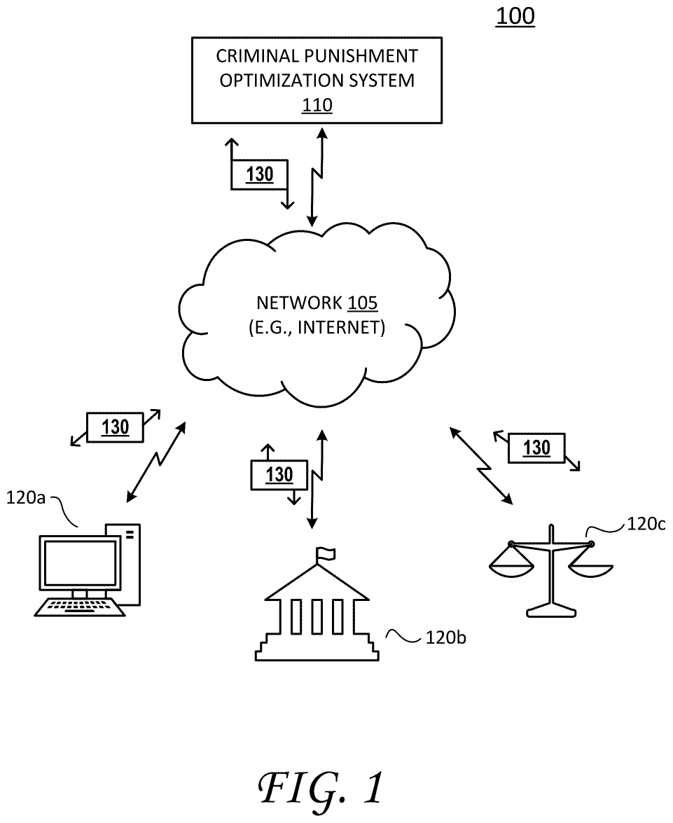

Referring to the figures, FIG. 1 illustrates a schematic diagram 100 of an example communication network 105 (e.g., the Internet). Communication network 105 is shown for purposes of illustration and represents various types of networks, including local area networks (LANs), wide area networks (WANs), telecommunication networks (e.g., 4G, 5G, etc.), and so on.

As shown, communication network 105 includes a geographically distributed set of nodes 120, such as local devices 120a (e.g., a computer, mobile device, electronic devices, etc.), courthouse devices 120b (e.g., servers, routers, sensors, computers, etc.) located at courthouses and related locations containing criminal data (e.g., Departments of Justice, National Crime Information Center (NCIC), law enforcement agencies, Law Enforcement Database Systems (LEDS) and equivalent state criminal record databases, foreign criminal databases, etc.), and/or legal office devices 120c (e.g., servers, routers, sensors, computers, etc.) located at legal offices and related locations (law offices, legal centers, etc.). These nodes 120 are interconnected by communication links and/or network segments and exchange or transport data such as data packets 130 to and from a criminal punishment optimization system 110. Nodes 120 may include various types of devices, such as, e.g., routers, servers, switches, sensors, computers, etc., which may be in communication with other nodes 120, based on distance, signal strength, current operational status, location, etc. Those skilled in the art will understand that any number of nodes, devices, links, etc. may be used in the communication network, and that the view shown herein is for simplicity.

Data packets 130 such as network traffic/messages are exchanged between nodes 120 and the criminal punishment optimization system 110 over and within communication network 105 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the devices or nodes interact with each other.

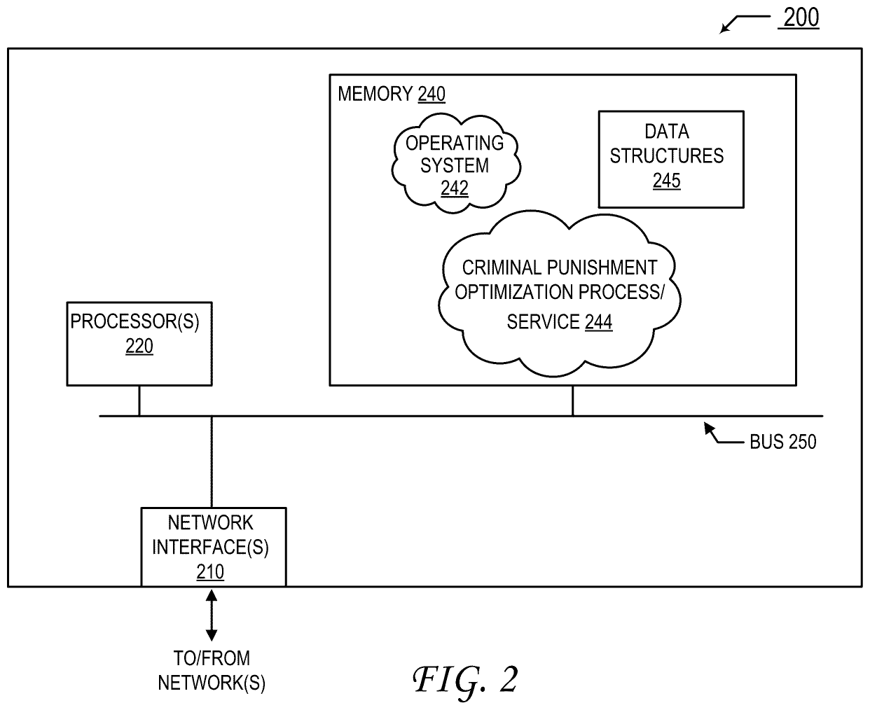

FIG. 2 is a schematic block diagram of an example node/device 200 that may be used with one or more embodiments described herein, e.g., as a component of the criminal punishment optimization system 110 and/or any of the nodes 120 shown in FIG. 1 above. Node/device 200 may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 contain the mechanical, electrical, and signaling circuitry for communicating data over links coupled to the network 105. Network interface 210 may be configured to transmit and/or receive data using a variety of different communication protocols. Network interface 210 is shown for simplicity, and it is appreciated that such interface may represent two different types of network connections, e.g., wireless and wired/physical connections. Also, while network interface 210 is shown separately from power supply 260, for PLC the interface may communicate through power supply 260, or may be an integral component of the power supply. In some specific configurations the PLC signal may be coupled to the power line feeding into the power supply.

Memory 240 comprises a plurality of storage locations that are addressable by processor 220 and network interfaces 210 for storing software programs and data structures associated with the embodiments described herein. Note that certain devices may have limited memory or no memory (e.g., no memory for storage other than for programs/processes operating on the device and associated caches).

Processor 220 may comprise hardware elements or hardware logic adapted to execute the software programs and manipulate data structures 245. An operating system 242, portions of which are typically resident in memory 240 and executed by the processor, functionally organizes the device by, inter alia, invoking operations in support of software processes and/or services executing on the device. These software processes and/or services may comprise criminal punishment optimization process/service 244, as described herein. Note that while criminal punishment optimization process/service 244 is shown in centralized memory 240, alternative embodiments provide for the process to be specifically operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while criminal punishment optimization process/service 244 is shown as a standalone process, those skilled in the art will appreciate that processes may be routines or modules within other processes.

As noted above, while recidivism rates have been used to measure the deterrent effect of criminal punishments, recidivism rates generally do not account for the costs of administering the criminal punishment on the judicial system or the costs of harm to society associated with the criminal behavior. Furthermore, while the general sentencing guidelines at the federal level provide for some practical and economic factors, they do not explicitly account for a quantifiable cost of harm to society or the cost to the judicial system associated with the criminal behavior, or other factors unique to an offender such as an offender's societal engagement. As current systems fail to account for these costs, criminal punishments may be administered in an extremely cost-ineffective manner, thereby costing taxpayers, the judicial system, and society millions of dollars more than required to reduce the recidivism rates. Moreover, by failing to account for those other factors, current systems fail to effectively optimize a punishment unique to that individual that effectively reduces their recidivism rate, while minimizing the actual costs to society. Thus, current systems fail to provide an optimized sentencing guideline for criminal punishments that balances the costs of administering the criminal punishment with reducing the recidivism rate for the criminal offender.

To illustrate, if a Judge were to solely rely on recidivism rates for determining a criminal sentence, a lifetime prison sentence would be optimal for all criminal sentencing, as the lifetime sentence would reduce all recidivate behavior. However, the judicial costs associated with the lifetime punishment may heavily outweigh the deterrent effect on future criminal behavior, resulting in additional undue costs to taxpayers and the criminal justice system. For example, an individual convicted of jaywalking may be deterred from future instances of jaywalking by a lifetime prison sentence, but that same individual may also be deterred from future instances of jaywalking by a one-year prison sentence, a three-month prison sentence, or even a steep fine. Thus, sentencing this individual to a lifetime prison sentence would provide a maximum deterrent effect and minimal recidivism risk, but at significant additional costs that were not necessary to deter the behavior and minimize recidivism. Moreover, in the above example, a three-month prison sentence may not deter future instances of jaywalking if an offender has little or no engagement with society, while another jaywalker who is actively engaged in society may be deterred by just the steep fine. Accordingly, as conventional techniques for determining a sentencing guideline for a specific type of criminal behavior fail to balance the costs to the judicial system and society with the recidivism rates associated with the type of criminal behavior, suboptimal punishments may be administered that cost taxpayers millions and unduly burden judicial system recourses.

The techniques described herein provide a system and method for optimizing criminal sentencing guidelines that maximize the deterrent effect of criminal punishments while minimizing recidivate behavior and the cost to taxpayers in implementing the criminal punishments. Generally, the systems and methods described herein compile various data points related to a criminal activity of a criminal offender, such as their criminal records, criminal sentence given, and costs associated with the criminal activity. In some embodiments, upon receipt of a trigger event or subsequent criminal activity by the criminal offender, the systems and methods analyze these data points as well as the new data points associated with the subsequent criminal activity to generate an optimized sentencing guideline that is optimized for the specific offender, balances the costs to the judicial system and society with the sentence, maximizes deterrence and minimizes recidivate behavior. Furthermore, the systems and methods may determine a cost savings per day for an optimized sentencing guideline that reflects the cost savings had the optimal criminal sentence been given in the first instance. Ultimately, this information would better allow legislators to create laws based in evidence, judges to determine sentencing arrangements to fit both the crime and the cost to the judicial infrastructure and to society, prosecutors to more effectively prioritize caseloads, defense services to budget their resources more effectively, defense attorneys to represent their client's interests more holistically, police officers to create more positive outcomes within interactions with the convicted, and probation officers to better work with their probationers.

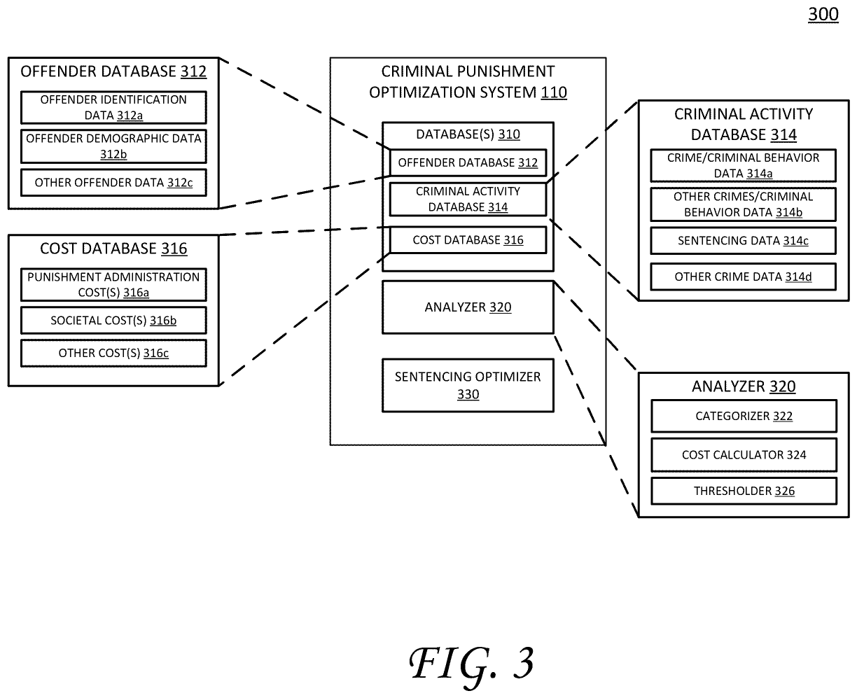

FIG. 3 illustrates a schematic block diagram 300 depicting the components of criminal punishment optimization system 110. Collectively, the components of criminal punishment optimization system 110 optimize criminal sentencing guidelines that maximize the deterrent effect of criminal punishments while minimizing recidivate behavior and the cost to taxpayers in implementing the criminal punishments.

As shown in FIG. 3, criminal punishment optimization system 110 includes one or more database(s) 310, an analyzer 320, and a sentencing optimizer 330.

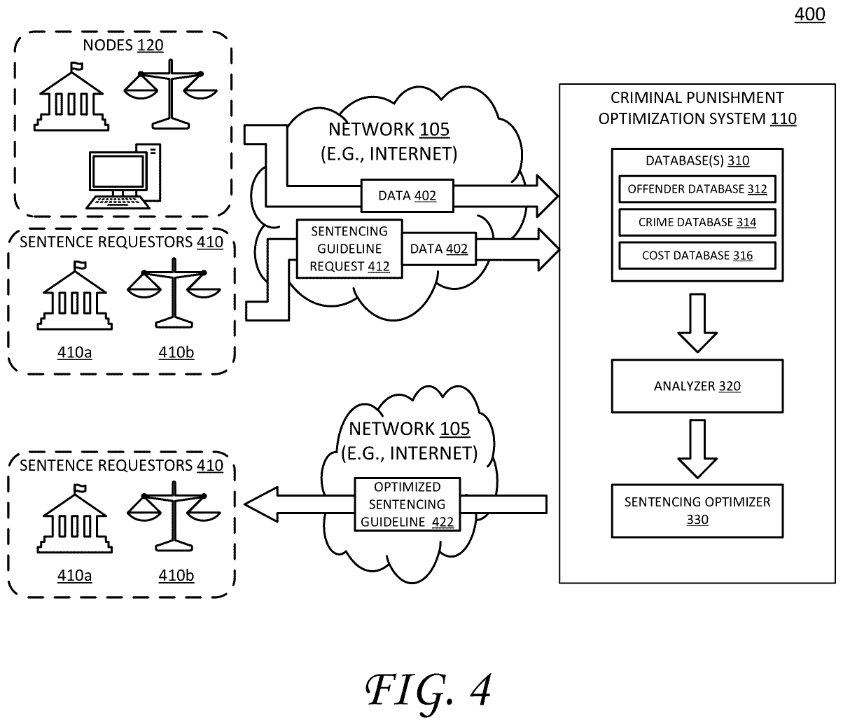

In some embodiments, the one or more database(s) 310 includes an offender database 312, a criminal activity database 314, and a cost database 316. As shown, each of the database(s) 310 includes a plurality of data associated with each of the database(s) 310. In other words, the offender database 312 includes data related to a criminal offender, the criminal activity database 314 includes data related to criminal activity of the criminal offender, and the cost database 316 includes data related to costs associated with the criminal activity of the criminal offender. The data included in database(s) 310 may include both historical data and real-time data accessed from nodes 120, as further discussed with respect to FIG. 4 below. While these databases are used to illustrate the concepts disclosed herein, it is appreciated that other types of databases, underlying data, and database organization may be used without departing from the concepts disclosed herein.

The offender database 312 represents data associated with an offender or a criminal engaged in criminal activity. The data contained in the offender database 312 includes offender identification data 312a, offender demographic data 312b, and other offender data 312c. In some embodiments, this data may collectively be referred to as offender personal information. In other embodiments, this data may collectively be referred to as criminal personal information. Offender identification data 312a includes a name, birthdate, social security number, identification number (e.g., state identification card number, driver license number, etc.), any known addresses, or any other data used to identify the offender. Offender demographic data 312b includes an age, height, weight, gender, nationality, ethnicity, marital status, income, education, or any other demographic information associated with the offender. Other offender data 312c includes any other data associated with the offender. For example, other offender data 312c may include known substance abuse, prior convictions, self-reported instances of criminal behavior that did not result in a conviction, addictions, mental/physical health diagnoses, family support systems, housing, employment, and career (current career and career goals). Collectively, the offender database 312 includes all the data associated with the offender. The offender database 312 of the criminal punishment optimization system 110 may receive the data associated with the offender from local devices 120a, courthouse devices 120b, and/or legal office devices 120c, and may be sourced from criminal records associated with the offender or any other personal records that provide data associated with the offender.

The criminal activity database 314 represents data associated with the criminal activity in which the offender engaged. The data contained in the criminal activity database 314 reflects the underlying data associated with previous instances of criminal activity as well as the underlying data associated with the criminal activity in which the offender engaged, and includes crime/criminal behavior data 314a, other crimes/criminal behavior data 314b, sentencing data 314c, and other crime data 314d.

Crime/criminal behavior data 314a includes a criminal record of a criminal or an offender engaged in criminal activity, and may include the date of the crime or criminal activity, substances involved in the crime/criminal behavior (including the quantity and timing of substances consumed), police contact information (including place and time of the initial police contact and source of the police contact, such as a traffic stop, 911 call, car accident, etc.), and if a vehicle was involved, the vehicle information (make, model, year, condition, etc.). Other crimes/criminal behavior data 314b includes any data related to other criminal behavior or crimes committed during the same instance of criminal activity. For example, if the criminal or offender was stopped for a DUI, ran from the police, and caused a car accident, the criminal activity database 314 would capture the evading police, reckless driving, causing a car accident, and any other related criminal behavior associated with the DUI as other crimes/criminal behavior data 314b.

Sentencing data 314c includes data associated with the ultimate sentencing for the criminal activity in which the criminal or offender engaged. For example, sentencing data 314c may include the sentence given (e.g., prison time, fines, community service, house arrest, combinations thereof, etc.), as well as the ultimate outcome of that sentence (e.g., early release for good behavior, parole given, reform programs offered for early release, etc.).

Other crime data 314d includes any other relevant data associated with the criminal activity of the criminal or offender. For example, the other crime data 314d may include data associated with the prison that the criminal or offender is ultimately sent to, including the location and type of prison, the time spent in the prison, the other convicts present in the prison, the prison ecosystem (e.g., gangs present, etc.), and any reform programs or similar programs (e.g., higher learning programs, scholarly programs, religious programs, etc.) offered by the prison. Collectively, the criminal activity database 314 includes all the data associated with the criminal activity in which the criminal or offender engaged.

The cost database 316 represents the monetary costs caused by the criminal activity of the criminal or offender. The data contained in the cost database 316 includes punishment administration cost(s) 316a, societal cost(s) 316b, and other cost(s) 316c. Punishment administration cost(s) 316a includes the monetary costs to the judicial system to punish the criminal or offender for the criminal activity. For example, the punishment administration cost(s) 316a may include court costs for conducting a criminal trial, public defender costs, district attorney costs, or any other costs associated with administering the criminal punishment for the criminal or offender. The punishment administration cost(s) 316a may further include the monetary costs to the judicial system to arrest the criminal or offender. For example, the costs for arresting the criminal or offender may include the costs for investigating an accident (e.g., cost to investigate a fatal DUI car accident, cost to clean crime scene, etc.) and/or costs incurred by law enforcement agencies in arresting the criminal or offender (e.g., cost to law enforcement agencies to execute a warrant, etc.).

Societal cost(s) 316b includes the costs to society caused by the criminal activity of the criminal or offender. For example, the societal cost(s) 316b may include monetary harm to property caused by the criminal activity, monetary harm to public infrastructure caused by the criminal activity (e.g., vandalism, damage to roadways, signs, medians, landscaping, etc.), and the monetary harm to others caused by the criminal activity (e.g., medical bills, quantifiable emotional distress, etc.). The societal cost(s) 316b may also include a tax cost reflecting what would have been collected from the taxable income of the criminal or offender and/or the victim if not for the criminal activity. To illustrate, if the criminal activity is a fatal DUI car accident, all future taxable income of the victim will be lost to the accident, as well as the future taxable income of the criminal or offender while the criminal or offender is incarcerated as a result of the fatal DUI car accident. Thus, the societal cost(s) 316b may include the tax cost of the victim based on the taxable income of the victim that would have been collected by the government had the accident not occurred, as well as the tax cost of the criminal or offender based on the taxable income the criminal or offender would have generated if not for the criminal or offender's incarceration.

Other cost(s) 316c includes any other cost(s) caused by the criminal activity of the criminal or offender. For example, some criminal activities may be considered “victimless crimes,” and may have very low or unquantifiable monetary costs associated with them. To illustrate, it may be difficult to determine a monetary cost to society or others for crimes such as jaywalking, possession of illegal contraband, recreational drug use, prohibited sexual behavior between consenting adults, etc. In these situations, the criminal punishment optimization system 110 may either solely rely on the punishment administration cost(s) 316a, or alternatively may assign a value for the other cost(s) 316c based on the specific crime. To illustrate, the criminal punishment optimization system 110 may assign and weigh a value for the other cost(s) 316c. In some embodiments, the criminal punishment optimization system 110 may assign a numerical value to each criminal activity in a category of crime (e.g., the “victimless crimes”), and weigh each criminal activity in the category of crime based on a perceived cost to society and adjust the numerical value for each criminal activity to reflect a scale of increasing societal cost. For example, in some embodiments, the criminal punishment optimization system 110 may determine the perceived cost to society for jaywalking is higher than the perceived cost of recreational drug use, and adjust their respective numerical values such that the numerical value assigned to jaywalking is higher than the numerical value assigned to recreational drug use. Collectively, the cost database 316 includes all the data associated with the monetary costs associated with the criminal activity of the offender.

In operation, the data collected into database(s) 310 is analyzed by the analyzer 320 for optimization by the sentencing optimizer 330. In some embodiments, the analyzer 320 may include a categorizer 322, a cost calculator 324, and a thresholder 326. While these components are used to illustrate the concepts disclosed herein, it is appreciated that other components and/or combinations of components may be used without departing from the concepts disclosed herein.

The categorizer 322 categorizes and modifies portions of the data for further analysis by the criminal punishment optimization system 110. For example, the categorizer 322 may categorize the data contained in the criminal activity database 314 into categories of harm based on a type of harm associated with the criminal activity. To illustrate, the categorizer 322 may categorize the criminal activity of the offender into a harm to people category, a harm to property category, a harm to entities category, and a harm to societal order category. The harm to people category reflects criminal activities that cause harm to others, such as murder, assault, battery, etc. The harm to property category reflects criminal activities that cause harm to other's property or chattel, such as vandalism, theft, trespass, etc. The harm to entities category reflects criminal activity that cause harm to other entities, such as business entities (e.g., corporations, Limited Liability Companies, Partnerships, Sole proprietorships, etc.), trusts, non-profit organizations, governmental entities, associations, cooperatives, or other similar entities that may be harmed by the criminal activity. The harm to societal order category reflects criminal activities that cause harm to society or the societal order. In some embodiments, the harm to the societal order category may not reflect harm to people or property, and include harms such as jaywalking, drug abuse, public intoxication, prostitution, etc. In some embodiments, the categorizer 322 may group multiple categories together. For example, in the case of a DUI, the categorizer 322 may categorize the type of harm as both a harm to people and property if the DUI caused a car accident that injured another person and damaged the injured person's vehicle. As another example, in the case of a drunk and disorderly offense, the categorizer 322 may categorize the type of harm as both a harm to property (if the disorderly conduct damaged another's property) and harm to the societal order (public intoxication). As each category of harm may have unique costs associated with the category of harm, the criminal punishment optimization system 110 may categorize each criminal activity of the offender into each respective type of harm category for further analysis by the analyzer 320. To illustrate, a cost of harm associated with the harm to people category (e.g., murder) may be significantly different than the cost of harm associated with the harm to societal order category (e.g., jaywalking). Thus, the criminal punishment optimization system 110 separates these categories of harm into their respective categories for determining an average cost of harm for the specific type of criminal activity to optimize a sentencing guideline for a specific instance of criminal activity.

In some embodiments, the categorizer 322 may also categorize and segment criminal records stored in the criminal activity database 314 based on whether the criminal record represents recidivate criminal behavior (a recidivate criminal record) or non-recidivate criminal behavior (a non-recidivate criminal record). As discussed above, recidivate criminal behavior refers to repeat offenses by the same criminal or offender. For example, the categorizer 322 may identify an initial criminal record for a specific criminal or offender and a subsequent criminal record for the same criminal or offender, for example by identifying the criminal personal information or offender personal information associated with the initial criminal record and the subsequent criminal record and determining the criminal personal information or offender personal information between the initial criminal record and the subsequent criminal record is a match. If a match is determined, the categorizer 322 would categorize the subsequent criminal record as a recidivate criminal record, as the subsequent criminal activity associated with the subsequent criminal record would indicate the criminal or offender engaged in repeat criminal activity or recidivate behavior. For other criminal records, if the criminal punishment optimization system 110 does not identify a subsequent criminal record associated with the specific offender, for example by determining there is not a match in the criminal personal information or offender personal information between criminal records from the criminal activity database 314, the categorizer 322 may categorize the initial criminal record as a non-recidivate criminal record. As the sentencing data 314c is associated with the criminal records stored within the criminal activity database 314, the sentences for the recidivate criminal records and the non-recidivate criminal records may be identified and correlated as well.

In some embodiments, the categorizer 322 may also categorize, modify and/or quantify datapoints in database(s) 310 based on their effect of reducing or increasing recidivism. To illustrate, in some embodiments, the categorizer 322 may generate a recidivism metric reflecting whether certain datapoints increase or decrease recidivism. These datapoints may include data and information from the offender database 312, criminal activity database 314, cost database 316, or a combination thereof. For example, if the criminal or offender is housed in a maximum security prison with known gang activity and minimal reformative programs, then the criminal or offender may have an increased risk of recidivism when the criminal or offender is released, as the criminal or offender may have joined a gang in the prison and will continue to engage in criminal activity for the gang after release, including activities that the criminal or offender may not have originally engaged in. In these embodiments, the categorizer 322 will assign a value to each datapoint (e.g., maximum security prison, known gang activity, and minimal reformative programs) according to a predetermined recidivism scale (0-10, 0-100, etc.), and weigh and aggregate the values into a single recidivism metric reflecting the criminal or offender's relative risk of recidivism. By quantifying these non-numerical datapoints and modifying them into a single recidivism metric, the criminal punishment optimization system 110 may account for the additional unique factors that prior systems fail to account, ultimately permitting any sentencing threshold determined by thresholder 326 to be adjusted and optimized for that specific criminal or offender.

In some embodiments, the categorizer 322 of the criminal punishment optimization system 110 may generate a societal engagement metric reflecting a relative connection to society for the criminal or offender. These datapoints may include data and information from the offender database 312, criminal activity database 314, cost database 316, or a combination thereof. For example, if the criminal or offender has low career aspirations and/or is disconnected from the society/community in which the criminal or offender is from, then the criminal or offender may have an increased risk of recidivism upon release as well. Further, should the criminal or offender be located in and/or released in a jurisdiction that is far from the criminal or offender's hometown, or is consistently a repeat offender, then the risk of recidivism may be higher as well. On the other hand, other datapoints analyzed by the categorizer 322 may indicate a decreased risk of recidivism. For example, if the criminal or offender is engaged in his hometown community and is located within that hometown community after release, then the risk of recidivism may decrease. Additionally, if the prison the criminal or offender is placed in has various reform programs and separates violent offenders from non-violent offenders, then the risk of recidivism may also decrease. In these embodiments, the categorizer 322 will assign a value to each datapoint (e.g., career aspirations, connection to society, location of the criminal activity compared to home address, prison conditions and reform programs available, etc.) according to a predetermined societal engagement scale (0-10, 0-100, etc.), and weigh and aggregate the values into a single societal engagement metric reflecting the criminal or offender's relative connection to society. By quantifying these non-numerical datapoints and modifying them into a single societal engagement metric, the criminal punishment optimization system 110 may account for the additional unique factors that prior systems fail to account, ultimately permitting any sentencing threshold determined by thresholder 326 to be adjusted and optimized for that specific criminal or offender. In some embodiments, the categorizer 322 may generate both the recidivism metric and the societal engagement metric. In some embodiments, the criminal punishment optimization system 110 will correlate and aggregate the recidivism metric and the societal engagement metric into a single offender metric that may be used to adjust and optimize the sentencing threshold determined by thresholder 326. In some other embodiments, the criminal punishment optimization system 110 will adjust and optimize the sentencing threshold based on the societal engagement metric and recidivism metric individually. It is appreciated that various other techniques and methods for quantifying the various datapoints of database(s) 310 into a recidivism metric, societal engagement metric, and/or an offender metric may also be implemented in the criminal punishment optimization system 110 and the techniques described herein are but an example of such quantification and modification.

As discussed, the criminal punishment optimization system 110 may account for these metrics (e.g., the recidivism metric, societal engagement metric, and/or offender metric) in identifying and adjusting a sentencing threshold as discussed below and ultimately optimizing the sentencing guideline. For example, if the recidivism metric, societal engagement metric, and/or an offender metric for a criminal or offender indicates a reduced risk of recidivism, the optimal sentencing guideline that minimizes recidivate behavior and costs to the judicial system and society may be less than the sentencing threshold determined as discussed below. On the other hand, if the recidivism metric, societal engagement metric, and/or an offender metric for a criminal or offender indicates an increased risk of recidivism, the optimal sentencing guideline may be significantly more than the sentencing threshold determined as discussed below. Thus, the adjusted sentencing threshold discussed below may also take these metrics into account in determining the optimal sentencing threshold for generating the optimized sentencing guideline.

In some other embodiments, the categorizer 322 may categorize other portions of the data for further analysis. For example, in machine-learning models described further below, the categorizer 322 may categorize the data in the offender database 312 to identify like-offenders in predicting an optimal sentencing guideline, as further described below. Collectively, the categorizer 322 may categorize, modify, or quantify any data from the database(s) 310 for further analysis and optimization.

The cost calculator 324 calculates cost to society values for the criminal activities associated with the criminal records, which may include a total cost for a specific instance of criminal activity and an average cost of harm associated with the categories of harm. The cost calculator 324 may take the data from the cost database 316 and for each specific instance of criminal activity, calculate a total cost for that specific instance of criminal activity. For example, if the criminal activity is a DUI, the cost calculator will total the punishment administration cost(s) 316a for charging, trying, and punishing the offender, the societal cost(s) 316b caused by the DUI (e.g., property damage to other vehicles, damage to others or property caused by the drunk driving, etc.), and any other cost(s) 316c associated with the DUI. Thus, the cost calculator 324 will be able to determine the total monetary cost associated with that DUI. The cost calculator 324 may perform this calculation for many different instances of criminal activity, and thus calculates a total cost for each instance of criminal activity stored within the database(s) 310. Additionally, as more data points are entered into database(s) 310, the cost calculator 324 may recalculate any total costs for any subsequent instance of criminal activity.

In some embodiments, the cost calculator 324 may also quantify an average cost of harm associated with the criminal activity of the criminal or offender. For example, once the categorizer 322 categorizes the criminal activity of the criminal or offender into a type of harm category, the cost calculator 324 may calculate an average cost of harm associated with the type of harm category based on averaging the total costs of harm for other criminal activities that are also part of the type of harm category of the criminal activity. Thus, the cost calculator 324 may also quantify an average cost of harm associated with the categories of harm. Additionally, the cost calculator 324 may recalculate the average cost of harm upon receipt of additional instances of criminal activity by other criminals or offenders in order to keep the average cost of harm associated with the criminal activity of the offender up to date.

The thresholder 326 identifies one or more thresholds based on the data contained within the database(s) 310. For example, once the categorizer 322 categorizes and segments the criminal records of a plurality of offenders into recidivate criminal records and non-recidivate criminal records and correlates the sentences to the criminal records as described above, the thresholder 326 may determine that a sentencing threshold separates a predetermined number of recidivate criminal records from a predetermined number of non-recidivate criminal records. To illustrate, should the analyzer 320 determine that for a specific category of harm, prison sentences of less than 1 year result in recidivate behavior by the offender while prison sentences of more than 1 year result in non-recidivate behavior of the offender, then the thresholder 326 would set a sentencing threshold of 1+ years for the specific category of harm. Collectively, the thresholder 326 reflects the threshold sentencing guideline that represents non-recidivate behavior for a particular sentence for particular criminal activity, thus enabling the criminal punishment optimization system 110 to determine which sentences result in repeat offenses, and which sentences result in successful deterrent of future criminal behavior.

The sentencing optimizer 330 will take the data that is analyzed by the analyzer 320, such as the costs of harm from the cost calculator 324 and metrics from the categorizer 322, and determine an optimized sentencing guideline for a new instance of criminal activity. As described above, failing to incorporate this cost data and metrics into the criminal sentencing guideline may result in a sentence that may deter future criminal activity at a monetary cost higher than necessary or fail to deter future criminal activity at the same monetary cost. Thus, a sentencing guideline failing to incorporate one or more of these costs or metrics would be unoptimized, as a lesser sentence may have the same deterrent effect while having a lower monetary cost, or a greater sentence may be necessary to have the same deterrent effect.

In some embodiments, the sentencing optimizer 330 may balance the cost of harm and offender metrics (e.g., the social engagement metric and/or recidivism metric) with the sentencing threshold to generate an adjusted sentencing threshold that is reflective of an optimal sentencing guideline. In these embodiments, the sentencing optimizer 330 will modify the sentencing threshold upward or downward based on the cost of harm and adjust the modified sentencing threshold based on whether the offender metrics reflect non-recidivate or recidivate behavior, such that the adjusted and modified sentencing threshold simultaneously minimizes the average cost of harm associated with the criminal activity while minimizing recidivate behavior. The sentencing optimizer 330 may then generate an optimized criminal sentencing guideline to provide to any person, party, or sentencing authority requesting the optimized sentencing guideline. In some embodiments, the sentencing threshold is adjusted based on the cost of harm calculated by the cost calculator 324, while in some other embodiments the sentencing threshold is adjusted based on the metrics generated by the categorizer 322.

In some embodiments, the sentencing optimizer 330 may also calculate the cost savings per day for a specific optimized sentencing guideline compared to previous sentences given. In these embodiments, the sentencing optimizer 330 will use the data from the database(s) 310 to determine, for a specific instance of recidivate criminal behavior, a cost of administering an original punishment for a first instance of criminal activity (“cost of punishment”), a cost (or predicted cost) of administering a subsequent punishment for a second instance of criminal activity (“cost of new crime”), and a time between the first instance of criminal activity and the second instance of criminal activity (“time between recidivate behavior”). In some embodiments, the sentencing optimizer 330 predicts a cost to administer punishment for the second instance of criminal activity based on a comparison of the second instance of criminal activity for the offender and the cost to society value for the criminal records of the type of harm category. The sentencing optimizer 330 then divides the cost of new crime by the time between recidivate behavior and subtracts the result from the cost of punishment divided by the time between recidivate behavior. The result of this equation is the cost savings per day for a specific optimized sentencing guideline. In some embodiments, both the optimized sentencing guideline and the cost savings per day are provided to the person/party requesting the optimized sentencing guideline.

In some embodiments, the sentencing optimizer 330 may employ a machine learning system that uses the data contained in database(s) 310 to train machine learning algorithms to predict optimal sentencing guidelines for new offenders based upon the new offender's data added to database(s) 310. For example, it is envisioned the sentencing optimizer 330 may input the plurality of datapoints stored in database(s) 310 into a machine learning algorithm to train the algorithm as to identify optimal sentencing guidelines for specific types of criminal behavior that optimizes reducing recidivism and minimizing judicial and societal costs using the techniques disclosed herein. In these embodiments, the person, party, or sentencing authority requesting the optimized sentencing guideline (e.g., a judge during sentencing of the new offender) could input specific data points related to the offender, and the criminal punishment optimization system 110 would provide an optimal sentencing guideline that maximizes the deterrent effect, minimizes the recidivate behavior upon release, and does not cost the taxpayers a cent more than required to maximize deterrence and minimize recidivism.

While these components are used to illustrate the concepts disclosed herein, it is appreciated that other components and/or combinations of components may be used without departing from the concepts disclosed herein. For example, it is contemplated that the analyzer 320 and sentencing optimizer 330 may be a single component with sub-components (e.g., categorizer 322, cost calculator 324, thresholder 326, machine learning algorithms, etc.) for analyzing the data from the database(s) 310 and providing an optimized sentencing guideline.

FIG. 4 illustrates a schematic block diagram 400 showing operations and data flow for criminal punishment optimization system 110. Generally, criminal punishment optimization system 110 receives data 402 from nodes 120 that form the database(s) 310 of criminal punishment optimization system 110. In particular, criminal punishment optimization system 110 will receive data 402 that includes both historical and/or real-time data 402 associated with criminal activity of an offender, such as the offender's criminal record. The data 402 is generally received from the nodes described in FIG. 1, such as local devices 120a (e.g., a computer, mobile device, electronic devices, etc.), courthouse devices 120b and related locations containing criminal data (e.g., Departments of Justice, National Crime Information Center (NCIC), law enforcement agencies, Law Enforcement Data Systems (LEDS) and equivalent state criminal record databases, foreign criminal databases, etc.), and/or legal office devices 120c. Additionally, data 402 may be compiled from various jurisdictions and areas. The data 402 received from nodes 120 ultimately form the database(s) 310 of criminal punishment optimization system 110.

As further illustrated in FIG. 4, criminal punishment optimization system 110 may receive a sentencing guideline request 412, or a request for a criminal sentencing guideline for an offender that engaged in a criminal activity, from a sentence requestors 410. Sentence requestors 410 may include any party or person that makes decisions around criminal sentencing. For example, sentence requestors 410 may include judges 410a determining sentencing for the offender and attorneys 410b working both sides of the aisle (e.g., district attorneys and public defenders) who are recommending sentences. Other sentence requestors 410 are also contemplated, including legislators legislating new criminal laws and sentences, police officers and probation offers working with the offenders, sentencing recommendation panels and/or groups that provide sentencing recommendations, and any other party/person who may request a sentencing guideline. Generally, the sentencing guideline request 412 will also include data 402 related to the offender for which the criminal sentencing guideline is requested.

Based on the sentencing guideline request 412, the criminal punishment optimization system 110 will then access the criminal records stored within the database(s) 310, such as the data 402 stored in the offender database 312 and the data 402 stored in the criminal activity database 314 (e.g., the crime/criminal behavior data 314a and the sentencing data 314c). Once these data points are accessed by criminal punishment optimization system 110, then analyzer 320 (or the categorizer 322) will group the criminal records into one or more categories based on types of harm, as described above. For example, if the offender engaged in criminal activity related to jaywalking, the analyzer 320 will group related criminal records from the database(s) 310 into the “harm to society” groupings. Thus, unrelated criminal records in the database(s) 310, such as criminal records for murder or theft, are excluded.

The analyzer 320 (or the cost calculator 324) quantifies an average cost of harm associated with the criminal behavior data for the specific category of harm associated with the criminal records. The analyzer 320 uses the data 402 stored in the cost database 316 to sum the total cost of harm for each instance of criminal behavior for the specific category of harm, then average the total cost of harms into the average cost of harm associated with the criminal behavior data for the specific category of harm associated with the criminal records.

The analyzer 320 (or the categorizer 322) determines which of the criminal records within selected category of harm represents a recidivate criminal record or a non-recidivate criminal record. For example, of the criminal records in the selected category of harm, the analyzer 320 determines some of the criminal records represent repeat offenders, and thus recidivate behavior, while other criminal records represent first-time offenders, or non-recidivate behavior. The analyzer 320 groups these criminal records as recidivate criminal records or non-recidivate criminal records based on this determination.

Once the analyzer 320 groups the criminal records into recidivate criminal records or non-recidivate criminal records, the analyzer 320 (or the thresholder 326) determines a sentencing threshold separates a predetermined number of recidivate criminal records from the non-recidivate criminal records. Thus, the analyzer 320 will have generated from the database(s) 310 an average cost of harm for the category of harm that the criminal activity of the offender belongs and a sentencing threshold that separates recidivate criminal records and non-recidivate criminal records.

In some embodiments, the analyzer 320 (or the categorizer 322) generates one or more of a recidivism metric and a societal engagement metric for the offender that engaged in the criminal activity. For example, the analyzer 320 will receive various datapoints providing offender personal information from database(s) 310 indicating a risk of recidivism (e.g., maximum security prison, known gang activity, and minimal reformative programs) or a connection to society (e.g., career aspirations, connection to society, location of the criminal activity compared to home address, prison conditions and reform programs available, etc.) and assign a value to each datapoint indicating a risk of recidivism according to a predetermined recidivism scale and each datapoint indicating a connection to society on a predetermined societal engagement scale. Once these values are assigned, the analyzer 320 weighs and aggregates the values into a single recidivism metric reflecting the offender's relative risk of recidivism and a single societal engagement metric reflecting the offender's relative connection to society.

The sentencing optimizer 330 then optimizes the sentencing threshold based on the average cost of harm to create an adjusted sentencing threshold. This adjusted sentencing threshold is then used to generate an optimized sentencing guideline 422 for that specific offender engaged in that specific criminal activity that may be provided back to sentence requestors 410. As described above, the sentencing optimizer 330 may optimize the sentencing threshold and create the adjusted sentencing threshold by balancing the average cost of harm with the sentencing threshold to determine the optimal criminal sentence that results in non-recidivate behavior while minimizing the costs associated with administering the criminal sentence. Additionally, the sentencing optimizer 330 may determine a cost savings per day for the optimal criminal sentence and provide the cost savings per day for the optimal criminal sentence with the optimized sentencing guideline 422. Furthermore, the sentencing optimizer 330 may rely on a machine-learning algorithm to input the data 402 from analyzer discussed above and output the optimized sentencing guideline 422 to be provided to the sentence requestors 410.

In some embodiments, sentencing optimizer 330 may also adjust the sentencing threshold based on the recidivism metric and/or the societal engagement metric discussed above. For example, the optimal criminal sentence for a specific criminal activity for an offender with an increased risk of recidivism indicated by the recidivism metric should be higher than another offender engaged in the same criminal activity having a decreased risk of recidivism indicated by the societal engagement metric. As another example, the optimal criminal sentence for a specific criminal activity for an offender with a decreased risk of recidivism indicated by the recidivism metric should be lower than another offender engaged in the same criminal activity having an increased risk of recidivism indicated by the societal engagement metric. Thus, the sentencing optimizer 330 may further adjust the sentencing threshold based on the increased or decreased risk of recidivism associated with the specific offender. Thus, criminal punishment optimization system 110 optimize criminal sentencing guidelines that maximize the deterrent effect of criminal punishments while minimizing recidivate behavior and the cost to taxpayers in implementing the criminal punishments.

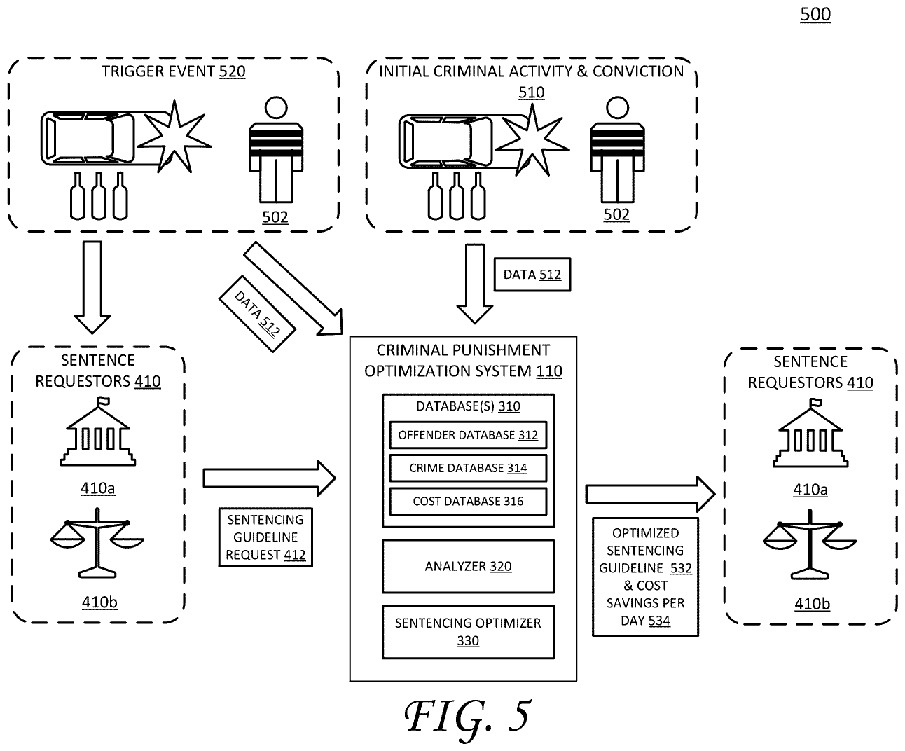

FIG. 5 illustrates a schematic block diagram 500 showing an end-to-end example of the criminal punishment optimization system 110 in accordance with some embodiments. In this example, an offender 502 engages in an initial instance of criminal activity and conviction 510, or as shown in FIG. 5, a driving under the influence (DUI) conviction. Criminal punishment optimization system 110 receives data 512 associated with the DUI conviction for offender 502, including, for example, identification data associated with the offender 502, data associated with the DUI conviction (e.g., car accident, quantity of alcohol consumed, vehicle information, etc.), data associated with other crimes/criminal behavior associated with the DUI conviction (e.g., reckless driving, driving with open container, etc.), sentencing data associated with the DUI conviction (e.g., 5 year prison sentence in state penitentiary), and cost data associated with the DUI conviction (cost to convict and administer punishment, cost of holding offender 502 in prison for 5 years, cost to society caused by DUI conviction such as infrastructure damage caused by car accident, etc.). This data 512 is all stored within database(s) 310 of criminal punishment optimization system 110.

Sometime later, the offender 502, engages in some type of trigger event 520. In some embodiments, the trigger event may be the death of offender 502. In these embodiments, the criminal record for offender 502 will be categorized as a non-recidivate criminal record, as no future instance of criminal behavior was committed by the offender 502. In other embodiments, the trigger event may be a new conviction for a different criminal activity or a new conviction of the same criminal activity.

In the example shown in FIG. 5, the offender 502, 2 years after being released from prison, engages in the same subsequent criminal activity (i.e., another DUI) and is convicted. As discussed, criminal punishment optimization system 110 receives the same or substantially the same data 512 for the subsequent criminal activity and conviction. However, for the subsequent DUI, the sentence requestors 410 (e.g., a judge determining the sentencing for offender 502) will send a sentencing guideline request 412 to criminal punishment optimization system 110. Criminal punishment optimization system 110 then calculates the variables as described above. For example, the analyzer 320 may categorize the DUI as a “harm to others and property” category, then group all criminal records related to “harm to others and property” into that category. The analyzer 320 may then quantify the cost of harm for the initial criminal activity and conviction 510 (e.g., $100,000), the trigger event 520 (e.g., $150,000), and the average cost of harm for criminal records in the “harm to others and property” category (e.g., $100,000 for 5 year sentence, $125,000 for 6 year sentence, $150,000 for 7 year sentence, etc.). Then, the analyzer 320 may categorize the criminal records in the “harm to others and property” category based on whether the criminal record indicates recidivate behavior (e.g., subsequent criminal activity) or indicates non-recidivate behavior (e.g., no subsequent criminal activity), and ultimately determine a sentencing threshold that separates the recidivate criminal records from the non-recidivate criminal records. For example, the sentencing threshold for this specific “harm to others and property” category may be a prison sentence of 6+years, where recidivate criminal behavior was found for prison sentences under 6 years while non-recidivate criminal behavior was found for prison sentences over 6 years. Further, the analyzer 320 may calculate the time between instances of criminal behavior for the offender 502, or here, the 2 years between the offender's 502 release from prison and the trigger event 520 (e.g., the repeat criminal activity).

Criminal punishment optimization system 110 then optimizes the sentencing threshold based on the average cost of harm to create an adjusted sentencing threshold and ultimately the optimized sentencing guideline 532, and calculates the cost savings per day 534 for the optimized sentencing guideline 532. First, the sentencing optimizer 330 will adjust the sentencing threshold to balance the average cost of harm, or here, will balance the sentencing threshold of 6+ years (representing any sentence over 6 years that provides maximum deterrent effect and minimizes recidivism) with the $125,000 average cost for a 6-year sentence (the minimum cost of harm to achieve the maximum deterrent effect and minimize recidivism) to result in an adjusted sentencing threshold of 6 years. Further, the sentencing optimizer 330 will take the cost of harm for the initial punishment ($100,000) and divide it by the time between instances of criminal behavior (2 years), and subtract this number from the cost of harm for the subsequent punishment ($150,000) by the time between instances of criminal behavior (2 years). This calculation results in a cost savings per year of $25,000, or a cost savings per day 534 of $68.50, had the initial sentence been optimized to the 6-year optimized sentencing guideline 532. Ultimately, criminal punishment optimization system 110 will provide the optimized sentencing guideline 532 (6-year prison sentence) with the cost savings per day 534 ($68.50 per day) to the sentence requestors 410 for further sentencing. Furthermore, as discussed above, if the offender 502 has an increased risk of recidivism based on the risk of recidivism metric and/or the societal engagement metric for the offender 502, then the optimized sentencing guideline 532 may be increased to a 7-year prison sentence in order to effectively reduce any recidivate behavior of the offender 502. On the other hand, if the offender 502 has a decreased risk of recidivism based on the risk of recidivism metric and/or the societal engagement metric, then the optimized sentencing guideline 532 may be reduced to a 5-year prison sentence at a lower cost to effectively reduce any recidivate behavior of the offender 502. As such, by incorporating the data and metrics described above and balancing them with the costs to the judicial system and society, criminal punishment optimization system 110 optimizes criminal sentencing guidelines that maximize the deterrent effect of criminal punishments while minimizing recidivate behavior and the cost to taxpayers in implementing the criminal punishments.

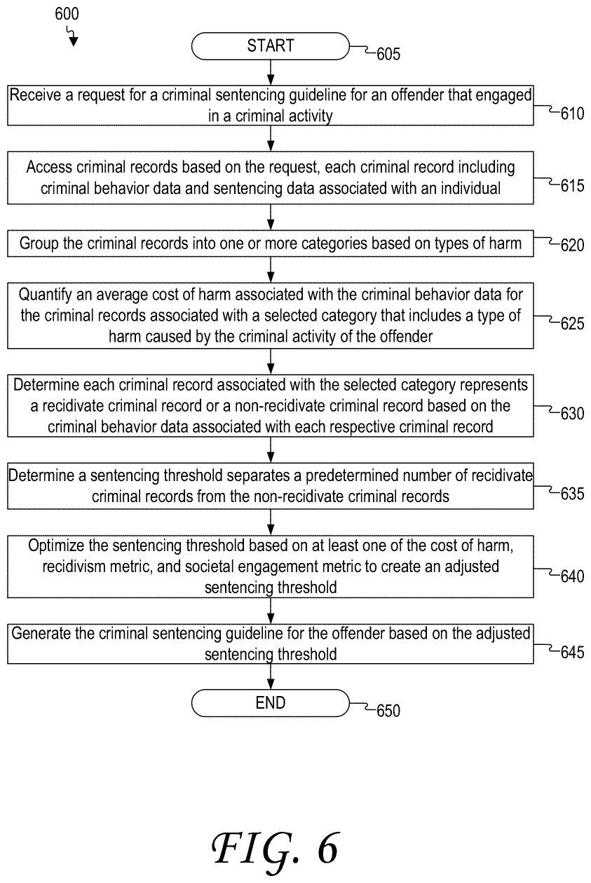

FIG. 6 illustrates an example simplified procedure for generating an optimized criminal sentencing guideline in accordance with one or more embodiments described herein. The procedure 600 may start at step 605, and continues to step 610, where, as described in greater detail above, the criminal punishment optimization system 110 receives a request for a criminal sentencing guideline for an offender that engaged in a criminal activity. The procedure 600 then continues to step 615, where, as described in greater detail above, the criminal punishment optimization system 110 accesses criminal records based on the request, each criminal record including criminal behavior data and sentencing data associated with an individual. The procedure 600 then continues to step 620, where, as described in greater detail above, the criminal punishment optimization system 110 groups the criminal records into one or more categories based on types of harm. The procedure 600 then continues to step 625, where, as described in greater detail above, the criminal punishment optimization system 110 quantifies an average cost of harm associated with the criminal behavior data for the criminal records associated with a selected category that includes a type of harm caused by the criminal activity of the offender. The procedure 600 then continues to step 630, where, as described in greater detail above, the criminal punishment optimization system 110 determines each criminal record associated with the selected category represents a recidivate criminal record or a non-recidivate criminal record based on the criminal behavior data associated with each respective criminal record. The procedure 600 then continues to step 635, where, as described in greater detail above, the criminal punishment optimization system 110 determines a sentencing threshold separates a predetermined number of recidivate criminal records from the non-recidivate criminal records. The procedure 600 then continues to step 640, where, as described in greater detail above, the criminal punishment optimization system 110 optimizes the sentencing threshold based on at least one of the cost of harm, recidivism metric, and societal engagement metric to create an adjusted sentencing threshold. The procedure 600 then continues to step 645, where, as described in greater detail above, the criminal punishment optimization system 110 generates the criminal sentencing guideline for the offender based on the adjusted sentencing threshold.

Procedure 600 subsequently ends at step 650, but may continue back to step 605 for other offenders and/or other sentences required for the same offender. It should be noted that certain steps within procedure 600 may be optional, and further, the steps shown in FIG. 6 are merely examples for illustration-certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, optimize criminal sentencing guidelines that maximize the deterrent effect of criminal punishments while minimizing recidivate behavior and the cost to taxpayers in implementing the criminal punishments. As discussed above, the techniques described herein may be utilized by various members of the justice system to achieve the ultimate goal of lessening crime and reforming the criminal, all while minimizing the costs associated with administering the judicial punishment, thereby saving taxpayers and society millions of dollars over time.

While there have been shown and described illustrative embodiments that optimize criminal sentencing guidelines, it is to be understood that various other adaptations and modifications may be made within the spirit and scope of the embodiments herein. For example, the embodiments and operations disclosed herein have been described with respect to certain devices, networks, databases, components, and external nodes, however it is appreciated that such embodiments are provided for purposes of example, not limitation.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly, this description is to be taken only by way of example and not to otherwise limit the scope of the embodiments herein. Therefore, it is the object of the appended claims to cover all such variations and modifications as come within the true spirit and scope of the embodiments herein.

Aspect 1. A criminal punishment optimization system, comprising: one or more network interfaces to communicate with a plurality of devices over a communication network; a processor coupled to the network interfaces and adapted to execute one or more processes; and a memory configured to store a process executable by the processor, the process, when executed is operable to: receive, from a device associated with a sentencing authority, a sentencing request to punish an offender convicted of a crime, the offender being associated with an offender criminal record and offender personal information; determine a type of harm for the offender criminal record based on at least one societal harm category; identify a group of criminal records from a criminal record database that are associated with the type of harm for the offender criminal record, each criminal record of the group of criminal records including at least data associated with a criminal behavior of a criminal; segment the group of criminal records into a group of recidivate criminal records and a group of non-recidivate criminal records based on the data associated with the criminal behavior of the criminal for each criminal record; determine a sentencing threshold separates the group of recidivate criminal records from the group of non-recidivate criminal records; generate a societal engagement metric for the offender based on the offender personal information, wherein the societal engagement metric is indicative of a connection to society for the offender; adjust the sentencing threshold based on the societal engagement metric for the offender to generate an adjusted sentence; and deliver the adjusted sentence to the device associated with the sentencing authority.

Aspect 2. The criminal punishment optimization system of aspect 1, wherein the process, when executed by the processor, is further operable to: generate a recidivism metric for the offender based on the offender personal information, wherein the recidivism metric is indicative of a risk of recidivate behavior by the offender; modify the adjusted sentence based on the recidivism metric to generate an updated sentence; and deliver the updated sentence to the device associated with the sentencing authority.

Aspect 3. The criminal punishment optimization system of aspect 1, wherein each criminal record of the group of criminal records further includes cost of harm data, wherein the process, when executed by the processor, is further operable to: determine a cost to society value for the group of criminal records based on an aggregate of the cost of harm data associated with each criminal record of the group of criminal records; predict a cost to administer punishment for the offender based on a comparison of the offender criminal record and the cost to society value for the group of criminal records; and modify the adjusted sentence based on the cost to administer punishment for the offender.

Aspect 4. The criminal punishment optimization system of aspect 1, wherein the process, when executed by the processor, is further operable to: determine an average judicial infrastructure cost for the recidivate criminal records, and wherein the process, when executed by the processor adjust the sentencing threshold, is further operable to adjust the sentencing threshold based on the average judicial infrastructure cost.

Aspect 5. The criminal punishment optimization system of aspect 1, wherein the societal harm category includes at least one of a harm to people category, a harm to property category, a harm to entities category, and a harm to society category.

Aspect 6. The criminal punishment optimization system of aspect 1, wherein the offender personal information includes one or more of demographic information, mental health information, physical health information, family support information, housing information, community engagement information, and career information.

Aspect 7. The criminal punishment optimization system of aspect 1, wherein the criminal behavior data includes data associated with a criminal behavior of the criminal, including one or more of a type of the criminal behavior, a time of the criminal behavior, a date of the criminal behavior, substances involved in the criminal behavior, location of the criminal behavior, and sentencing for the criminal behavior.

Aspect 8. A method for optimizing criminal sentencing comprising: receiving, from a device associated with a sentencing authority, a sentencing request to punish an offender convicted of a crime, the offender being associated with an offender criminal record and offender personal information; determining a type of harm for the offender criminal record based on at least one societal harm category; identifying a group of criminal records from a criminal record database that are associated with the type of harm for the offender criminal record, each criminal record of the group of criminal records including at least data associated with a criminal behavior of a criminal; segmenting the group of criminal records into a group of recidivate criminal records and a group of non-recidivate criminal records based on the data associated with the criminal behavior of the criminal for each criminal record; determining a sentencing threshold separates the group of recidivate criminal records from the group of non-recidivate criminal records; generating a societal engagement metric for the offender based on the offender personal information, wherein the societal engagement metric is indicative of a connection to society for the offender; adjusting the sentencing threshold based on the societal engagement metric for the offender to generate an adjusted sentence; and delivering the adjusted sentence to the device associated with the sentencing authority.

Aspect 9. The method for optimizing criminal sentencing of aspect 8, further comprising: generating a recidivism metric for the offender based on the offender personal information, wherein the recidivism metric is indicative of a risk of recidivate behavior by the offender; modifying the adjusted sentence based on the recidivism metric to generate an updated sentence; and delivering the updated sentence to the device associated with the sentencing authority.

Aspect 10. The method for optimizing criminal sentencing of aspect 8, wherein each criminal record of the group of criminal records further includes cost of harm data, the method further comprising: determining a cost to society value for the group of criminal records based on an aggregate of the cost of harm data associated with each criminal record of the group of criminal records; predicting a cost to administer punishment for the offender based on a comparison of the offender criminal record and the cost to society value for the group of criminal records; and modifying the adjusted sentence based on the cost to administer punishment for the offender.

Aspect 11. The method for optimizing criminal sentencing of aspect 8, further comprising: determining an average judicial infrastructure cost for the recidivate criminal records, and wherein modifying the sentencing threshold further comprises, modifying the sentencing threshold based on the average judicial infrastructure cost.

Aspect 12. The method for optimizing criminal sentencing of aspect 8, wherein the societal harm category including at least one of a harm to people category, a harm to property category, a harm to entities category, and a harm to society category.

Aspect 13. The method for optimizing criminal sentencing of aspect 8, wherein the offender personal information includes one or more of demographic information, mental health information, physical health information, family support information, housing information, community engagement information, and career information.

Aspect 14. The method for optimizing criminal sentencing of aspect 8, wherein the criminal behavior data includes data associated with a criminal behavior of the criminal, including one or more of a type of the criminal behavior, a time of the criminal behavior, a date of the criminal behavior, substances involved in the criminal behavior, location of the criminal behavior, and sentencing for the criminal behavior.

Aspect 15. A tangible, non-transitory, computer-readable media having instructions encoded thereon, the instructions, when executed by a processor, are operable to: receive, from a device associated with a sentencing authority, a sentencing request to punish an offender convicted of a crime, the offender being associated with an offender criminal record and offender personal information; determine a type of harm for the offender criminal record based on at least one societal harm category; identify a group of criminal records from a criminal record database that are associated with the type of harm for the offender criminal record, each criminal record of the group of criminal records including at least data associated with a criminal behavior of a criminal; segment the group of criminal records into a group of recidivate criminal records and a group of non-recidivate criminal records based on the data associated with the criminal behavior of the criminal for each criminal record; determine a sentencing threshold separates the group of recidivate criminal records from the group of non-recidivate criminal records; generate a societal engagement metric for the offender based on the offender personal information, wherein the societal engagement metric is indicative of a connection to society for the offender; adjust the sentencing threshold based on the societal engagement metric for the offender to generate an adjusted sentence; and deliver the adjusted sentence to the device associated with the sentencing authority.

Aspect 16. The tangible, non-transitory, computer-readable media of aspect 15, wherein the instructions, when executed by a processor, are further operable to: generate a recidivism metric for the offender based on the offender personal information, wherein the recidivism metric is indicative of a risk of recidivate behavior by the offender; modify the adjusted sentence based on the recidivism metric to generate an updated sentence; and deliver the updated sentence to the device associated with the sentencing authority.

Aspect 17. The tangible, non-transitory, computer-readable media of aspect 15, wherein each criminal record of the group of criminal records further includes cost of harm data, wherein the instructions, when executed by a processor, are further operable to: determine a cost to society value for the group of criminal records based on an aggregate of the cost of harm data associated with each criminal record of the group of criminal records; predict a cost to administer punishment for the offender based on a comparison of the offender criminal record and the cost to society value for the group of criminal records; and modify the adjusted sentence based on the cost to administer punishment for the offender.

Aspect 18. The tangible, non-transitory, computer-readable media of aspect 15, wherein the instructions, when executed by a processor, are further operable to: determine an average judicial infrastructure cost for the recidivate criminal records, and wherein the instructions, when executed by a processor to adjust the sentencing threshold, are further operable to adjust the sentencing threshold based on the average judicial infrastructure cost.

Aspect 19. The tangible, non-transitory, computer-readable media of aspect 15, wherein the societal harm category includes at least one of a harm to people category, a harm to property category, a harm to entities category, and a harm to society category.

Aspect 20. The tangible, non-transitory, computer-readable media of aspect 15, wherein the offender personal information includes one or more of demographic information, mental health information, physical health information, family support information, housing information, community engagement information, and career information.

1. A criminal punishment optimization system, comprising:
one or more network interfaces to communicate with a plurality of devices over a communication network;
a processor coupled to the network interfaces and adapted to execute one or more processes; and
a memory configured to store a process executable by the processor, the process, when executed is operable to:
receive, from a device associated with a sentencing authority, a sentencing request to punish an offender convicted of a crime, the offender being associated with an offender criminal record and offender personal information;
determine a type of harm for the offender criminal record based on at least one societal harm category;
identify a group of criminal records from a criminal record database that are associated with the type of harm for the offender criminal record, each criminal record of the group of criminal records including at least data associated with a criminal behavior of a criminal;
segment the group of criminal records into a group of recidivate criminal records and a group of non-recidivate criminal records based on the data associated with the criminal behavior of the criminal for each criminal record;
determine a sentencing threshold separates the group of recidivate criminal records from the group of non-recidivate criminal records;
generate a societal engagement metric for the offender based on the offender personal information, wherein the societal engagement metric is indicative of a connection to society for the offender;
adjust the sentencing threshold based on the societal engagement metric for the offender to generate an adjusted sentence; and
deliver the adjusted sentence to the device associated with the sentencing authority.

2. The criminal punishment optimization system of claim 1, wherein the process, when executed by the processor, is further operable to:
generate a recidivism metric for the offender based on the offender personal information, wherein the recidivism metric is indicative of a risk of recidivate behavior by the offender;
modify the adjusted sentence based on the recidivism metric to generate an updated sentence; and
deliver the updated sentence to the device associated with the sentencing authority.

3. The criminal punishment optimization system of claim 1, wherein each criminal record of the group of criminal records further includes cost of harm data, wherein the process, when executed by the processor, is further operable to:
determine a cost to society value for the group of criminal records based on an aggregate of the cost of harm data associated with each criminal record of the group of criminal records;
predict a cost to administer punishment for the offender based on a comparison of the offender criminal record and the cost to society value for the group of criminal records; and
modify the adjusted sentence based on the cost to administer punishment for the offender.

4. The criminal punishment optimization system of claim 1, wherein the process, when executed by the processor, is further operable to:
determine an average judicial infrastructure cost for the recidivate criminal records, and
wherein the process, when executed by the processor adjust the sentencing threshold, is further operable to adjust the sentencing threshold based on the average judicial infrastructure cost.

5. The criminal punishment optimization system of claim 1, wherein the societal harm category includes at least one of a harm to people category, a harm to property category, a harm to entities category, and a harm to society category.

6. The criminal punishment optimization system of claim 1, wherein the offender personal information includes one or more of demographic information, mental health information, physical health information, family support information, housing information, community engagement information, and career information.

7. The criminal punishment optimization system of claim 1, wherein the criminal behavior data includes data associated with a criminal behavior of the criminal, including one or more of a type of the criminal behavior, a time of the criminal behavior, a date of the criminal behavior, substances involved in the criminal behavior, location of the criminal behavior, and sentencing for the criminal behavior.

8. A method for optimizing criminal sentencing comprising:
receiving, from a device associated with a sentencing authority, a sentencing request to punish an offender convicted of a crime, the offender being associated with an offender criminal record and offender personal information;
determining a type of harm for the offender criminal record based on at least one societal harm category;
identifying a group of criminal records from a criminal record database that are associated with the type of harm for the offender criminal record, each criminal record of the group of criminal records including at least data associated with a criminal behavior of a criminal;
segmenting the group of criminal records into a group of recidivate criminal records and a group of non-recidivate criminal records based on the data associated with the criminal behavior of the criminal for each criminal record;
determining a sentencing threshold separates the group of recidivate criminal records from the group of non-recidivate criminal records;
generating a societal engagement metric for the offender based on the offender personal information, wherein the societal engagement metric is indicative of a connection to society for the offender;
adjusting the sentencing threshold based on the societal engagement metric for the offender to generate an adjusted sentence; and
delivering the adjusted sentence to the device associated with the sentencing authority.

9. The method for optimizing criminal sentencing of claim 8, further comprising:
generating a recidivism metric for the offender based on the offender personal information, wherein the recidivism metric is indicative of a risk of recidivate behavior by the offender;
modifying the adjusted sentence based on the recidivism metric to generate an updated sentence; and
delivering the updated sentence to the device associated with the sentencing authority.

10. The method for optimizing criminal sentencing of claim 8, wherein each criminal record of the group of criminal records further includes cost of harm data, the method further comprising:
determining a cost to society value for the group of criminal records based on an aggregate of the cost of harm data associated with each criminal record of the group of criminal records;
predicting a cost to administer punishment for the offender based on a comparison of the offender criminal record and the cost to society value for the group of criminal records; and
modifying the adjusted sentence based on the cost to administer punishment for the offender.

11. The method for optimizing criminal sentencing of claim 8, further comprising:
determining an average judicial infrastructure cost for the recidivate criminal records, and
wherein modifying the sentencing threshold further comprises, modifying the sentencing threshold based on the average judicial infrastructure cost.

12. The method for optimizing criminal sentencing of claim 8, wherein the societal harm category including at least one of a harm to people category, a harm to property category, a harm to entities category, and a harm to society category.

13. The method for optimizing criminal sentencing of claim 8, wherein the offender personal information includes one or more of demographic information, mental health information, physical health information, family support information, housing information, community engagement information, and career information.

14. The method for optimizing criminal sentencing of claim 8, wherein the criminal behavior data includes data associated with a criminal behavior of the criminal, including one or more of a type of the criminal behavior, a time of the criminal behavior, a date of the criminal behavior, substances involved in the criminal behavior, location of the criminal behavior, and sentencing for the criminal behavior.

15. A tangible, non-transitory, computer-readable media having instructions encoded thereon, the instructions, when executed by a processor, are operable to:
receive, from a device associated with a sentencing authority, a sentencing request to punish an offender convicted of a crime, the offender being associated with an offender criminal record and offender personal information;
determine a type of harm for the offender criminal record based on at least one societal harm category;
identify a group of criminal records from a criminal record database that are associated with the type of harm for the offender criminal record, each criminal record of the group of criminal records including at least data associated with a criminal behavior of a criminal;
segment the group of criminal records into a group of recidivate criminal records and a group of non-recidivate criminal records based on the data associated with the criminal behavior of the criminal for each criminal record;
determine a sentencing threshold separates the group of recidivate criminal records from the group of non-recidivate criminal records;
generate a societal engagement metric for the offender based on the offender personal information, wherein the societal engagement metric is indicative of a connection to society for the offender;
adjust the sentencing threshold based on the societal engagement metric for the offender to generate an adjusted sentence; and
deliver the adjusted sentence to the device associated with the sentencing authority.

16. The tangible, non-transitory, computer-readable media of claim 15, wherein the instructions, when executed by a processor, are further operable to:
generate a recidivism metric for the offender based on the offender personal information, wherein the recidivism metric is indicative of a risk of recidivate behavior by the offender;
modify the adjusted sentence based on the recidivism metric to generate an updated sentence; and
deliver the updated sentence to the device associated with the sentencing authority.

17. The tangible, non-transitory, computer-readable media of claim 15, wherein each criminal record of the group of criminal records further includes cost of harm data, wherein the instructions, when executed by a processor, are further operable to:
determine a cost to society value for the group of criminal records based on an aggregate of the cost of harm data associated with each criminal record of the group of criminal records;
predict a cost to administer punishment for the offender based on a comparison of the offender criminal record and the cost to society value for the group of criminal records; and
modify the adjusted sentence based on the cost to administer punishment for the offender.

18. The tangible, non-transitory, computer-readable media of claim 15, wherein the instructions, when executed by a processor, are further operable to:
determine an average judicial infrastructure cost for the recidivate criminal records, and
wherein the instructions, when executed by a processor to adjust the sentencing threshold, are further operable to adjust the sentencing threshold based on the average judicial infrastructure cost.

19. The tangible, non-transitory, computer-readable media of claim 15, wherein the societal harm category includes at least one of a harm to people category, a harm to property category, a harm to entities category, and a harm to society category.

20. The tangible, non-transitory, computer-readable media of claim 15, wherein the offender personal information includes one or more of demographic information, mental health information, physical health information, family support information, housing information, community engagement information, and career information.
